(19) United States
(12) Patent Application Publication
(10) Pub. No.: US 2025/0251298 A1
(43) Pub. Date: Aug. 7, 2025

(54) DRONE-BASED GAS LEAK IMAGING AND REPORTING WITH AUTOMATIC SEGMENTATION, ANNOTATION, AND NORMALIZATION

(71) Applicant: AerialOGI, LLC, Bountiful, UT (US)

(72) Inventors: William Barrows Peale, Berkeley, CA (US); Eric Neil Olsen, Bountiful, UT (US)

(21) Appl. No.: 19/044,362

(22) Filed: Feb. 3, 2025

Related U.S. Application Data
(60) Provisional application No. 63/627,993, filed on Feb. 1, 2024.

(51) Int. Cl. G01M 3/04; G01C 21/20

(52) U.S. Cl. CPC G01M 3/04; G01C 21/20

(57) ABSTRACT

According to various embodiments, a drone is configured with a camera and is in communication with onboard control systems and/or control systems in remote devices to detect and report gas leaks during flights. The control subsystems enable uniform incident reporting and imaging using specialized optical sensors and color schemes. The presently described systems and methods enable efficient detection, annotation, and reporting of gas leaks utilizing a unique combination and configuration of drone technology, video capture, artificial intelligence (AI), and data integration.

### RELATED APPLICATIONS

This Application Claims priority to and benefit under 35 U.S.C. 119 to U.S. Provisional Patent Application No. 63/627,993, filed on Feb. 1, 2024, titled “Drone-Based Gas Leak Imaging and Reporting with Automatic Segmentation, Annotation, and Normalization,” which application is hereby incorporated by reference in its entirety.

### TECHNICAL FIELD

This disclosure relates to gas leakage detection and imaging. More particularly, this disclosure relates to reporting and imaging gas leakage in remote locations.

### BRIEF DESCRIPTION OF THE DRAWINGS

Non-limiting and non-exhaustive embodiments of the disclosure are described herein, including various embodiments of the disclosure with reference to the figures listed below.

FIG. 1 illustrates a block diagram of an example detection system, according to one embodiment.

FIG. 2 illustrates a block diagram of portions a detection system that are implemented as computer-readable instructions, according to one embodiment.

FIG. 3 illustrates a flow chart of a method for detecting a gas leak and segmenting, annotating, and normalizing captured video for standardized reporting, according to one embodiment.

FIG. 4 illustrates another flow chart of a method for detecting a gas leak and segmenting, annotating, and normalizing captured video for standardized reporting, according to one embodiment.

FIG. 5 illustrates a screenshot of a live video feed from a drone with a control interface and a detected leak shown in a gas detection mode (GDM mode), according to one embodiment.

FIG. 6 illustrates a screenshot of a video feed from a drone during the application of a non-uniformity correction (NUC) mode applying a flat-field correction (FFC), according to one embodiment.

FIG. 7 illustrates a screenshot of a video feed from a drone with the manual controls disabled during a video annotation and automatic capture of a detected gas leakage event, according to one embodiment.

FIG. 8 illustrates a screenshot of the video feed from the drone with the manual controls enabled after the video annotation and/or automatic capture is completed, according to one embodiment.

FIG. 9 illustrates a screenshot and block diagram of a complete video file being processed by a reporting subsystem to extract and generate individual segmented and annotated video clips of each detected gas leakage event, according to one embodiment.

FIG. 10A illustrates a consolidated report in HTML format that allows for individual review of each of the segmented and annotated video clips of the detected gas leakage events, according to one embodiment.

FIG. 10B illustrates an example segmented and annotated video clip of a gas leakage event, according to one embodiment.

FIG. 10C illustrates an example segmented and annotated video clip of another gas leakage event, according to one embodiment.

FIG. 11A illustrates a screenshot of a live video feed and control interface of a drone with a white-hot image rendering of a detected gas leakage event, according to one embodiment.

FIG. 11B illustrates a screenshot of a live video feed and control interface of a drone with a black-hot image rendering of a detected gas leakage event, according to one embodiment.

FIG. 11C illustrates a screenshot of a live video feed and control interface of a drone with a white-hot image rendering of a detected gas leakage event in GDB mode with the gas movement rendered in green, according to one embodiment.

### DETAILED DESCRIPTION

Existing methods for gas leak detection and reporting involve manual processes that are time-consuming, lack precision, and lack uniformity. Conventional UAV-based approaches rely on subjective human observation, leading to inconsistent reporting and inefficient response efforts. Uniform incident reports facilitate accurate comparisons of detected leaks, prioritization of leaks, and/or repair estimates and recommendations. Artificial intelligence (AI) and/or machine learning (ML) algorithms may be utilized to detect gas leaks based on video imaging and/or still-frame image comparisons. Similarly, AI and/or ML algorithms may be utilized to quantify a detected gas leak, characterize a detected gas leak, generate a report summarizing characteristics of a detected gas leak, and/or provide recommendations for repairing a detected gas leak. Additionally, automated flight control, metadata embedding, and seamless integration with third-party leak detection and repair (LDAR) management systems ensure a comprehensive and standardized approach to leak detection and reporting.

According to various embodiments, a drone may include onboard computing resources (e.g., hardware and/or software to be implemented by processors, microprocessors, microcontrollers, etc.) configured to implement some or all aspects of the gas leakage detection, gas leak imaging, and/or report generation approaches described herein. This “onboard computing” approach may allow for the lowest latency and provide a fully integrated system that functions as a stand-alone package. However, this approach requires significant onboard computing resources and consumes more power than approaches in which some or all aspects of the computing are performed remotely (e.g., locally “offboard” or in remote servers or cloud-based implementations). To mitigate these power and processing constraints, the system may selectively offload certain computational tasks, such as report generation and data processing, to remote computing resources when necessary.

In some embodiments, the UAV may include an infrared core to enhance gas leak detection capabilities over extended distances. The infrared core may allow for higher-resolution thermal imaging and increased sensitivity to temperature differentials, enabling the system to detect gas leaks from greater altitudes or remote locations. Additionally, the system may be configured to support a competitor core, allowing for comparisons between different infrared imaging technologies to optimize detection accuracy.

To facilitate seamless communication and data transmission, the UAV may be equipped with a satellite modem for connectivity in areas without traditional wireless network coverage. The satellite modem may enable real-time data uploads, remote monitoring, and integration with cloud-based processing systems. In some embodiments, the UAV may leverage, for example, an Iridium network, to provide a reliable, global communication link for data transfer and remote operation.

Some or all aspects of gas leakage detection, gas leak imaging, and incident report generation may be implemented by computing resources in a locally connected device, such as a laptop or tablet, in wireless communication with the UAV (e.g., radio-connected). Additionally, secure communication protocols, including encryption mechanisms, ensure the integrity and confidentiality of transmitted data when integrating with LDAR workflows. In some embodiments, some or all aspects of gas leakage detection, gas leak imaging, and incident report generation may be implemented by computing resources in remote internet-connected computing resources (e.g., remote servers or cloud computing resources). In such embodiments, the UAV may be connected to the internet or remote network via an LTE (e.g., 5G) wireless network, a satellite connection, or via a radio-connected controller, tablet, or laptop that is connected to the internet via a wired or wireless network.

According to various embodiments, the presently described systems and methods may include and/or be implemented using a drone or other unmanned aerial vehicle (UAV) capable of stationary flight, panning, and/or rotating. The UAV may be equipped with one or more high-resolution cameras capable of imaging visible light, infrared light, ultraviolet light, and/or other specific spectrums of electromagnetic radiation, as described in greater detail herein. In certain embodiments, the UAV further includes an auxiliary visible light camera configured to capture visual confirmation images of the gas leakage event, complementing the infrared video feed. The camera may be fixed with respect to the UAV, such that all imaging is controlled based on movements and direction pointing of the UAV itself. In other embodiments, one or more imaging devices (e.g., cameras, lasers, lidar systems, etc.) are moveable with respect to the UAV. For example, a camera may be positioned on a gimble that allows for selective control of the yaw, pitch, and/or roll of the camera with respect to the UAV. The system may report metadata indicative of the yay, pitch, and/or roll of the camera with respect to the compass heading and GPS location of the drone for each frame or video image to facilitate a complete spatial understanding of the gas leakage and surrounding equipment and terrain.

In some embodiments, the system includes a leakage detection subsystem to detect gas leakage in captured video images. The leakage detection subsystem may, for example, utilize trained machine learning algorithms to detect the movement of gas using infrared imaging data and/or laser-based gas detection subsystems. For improved accuracy, the detection subsystem may incorporate a laser-based gas detection system capable of identifying specific gas types and overlaying gas concentration data onto the video feed. In other embodiments, the UAV may not include a leakage detection system and instead relies on a manual operator (locally connected via a radio controller within a few kilometers or remotely connected over many kilometers via the internet) to identify a gas leak in a live video feed. Additionally, the metadata embedding module may further insert environmental parameters such as air temperature, humidity, and atmospheric pressure at the time of the gas leakage event to improve leak characterization.

The system may include an incident reporting subsystem that is triggered to generate a video annotation in response to an identified gas leak. That is, regardless of whether the system automatically detects a gas leak or a human operator identifies a gas leak, an incident reporting subsystem may be triggered to generate a “video annotation” that annotates the recorded video with metadata and/or creates a separate video clip in real time that marks the specific location and time within the video feed that includes the gas leak. The system may then autonomously adjust UAV positioning by modifying its altitude and orientation relative to the detected gas leakage event to ensure consistent capture conditions. For example, the incident reporting system may automatically segment the video clip or generate a separate video clip file with a fixed duration (e.g., 1 second, 5 seconds, 10 seconds, 30 seconds, etc.) for each detected leak during a complete surveillance flight.

Each segmented and annotated video clip may include video imaging of the detected or identified gas leak using a non-uniformity correction (NUC) algorithm to eliminate image non-uniformity in the captured video. For example, the NUC algorithm may include the use of spectral shaping statistics, least mean square (LMS) methods, statistical analysis, scene-based NUC algorithms, and/or other NUC algorithms known to those skilled in the art. Each segmented and annotated video clip may be automatically captured by the UAV using a consistent set of imaging characteristics. For example, each segmented and annotated video clip may be the same duration, include images of the gas leak from the same distance, include images of the gas leak from the same angles, and/or the like.

Each segmented and annotated video clip may include metadata and/or otherwise be associated with comprehensive data packets containing date information, time information, GPS coordinates, wind speed information, wind direction information, air temperature information, leak temperature information, gas container or infrastructure temperature information, terrain temperature information, location of the sun, and/or the like. The segmented and annotated video clips may be packaged and/or otherwise configured for seamless integration with external (e.g., existing) leak detection and repair (LDAR) software. For example, the incident reporting subsystem may generate incident reports with segmented and annotated video clips that are compatible with REST-based application programming interfaces (APIs) for seamless integration with customer LDAR software. In some embodiments, the metadata embedded within the annotated video clip further includes an operator identifier and UAV system diagnostics data to assist in post-flight analysis.

The presently described system may further include a GPS-guided autonomous flight mode that enables the UAV to perform systematic surveys of an inspection area without manual control. This feature allows the system to conduct pre-programmed flight patterns, ensuring thorough surveillance of high-risk infrastructure. The reporting subsystem processes the continuous video feed by extracting standardized video clips, formatting them into incident reports, and integrating them into third-party LDAR management systems. These reports may be transmitted via secure communication protocols, which may include encryption for data integrity and authentication.

The extracted standardized video clips and associated metadata may be stored locally or transmitted to a cloud-based database for remote access and long-term analysis. This storage capability allows operators to retrieve and review historical data for predictive maintenance and regulatory reporting. By automating gas leak detection, annotation, UAV positioning, metadata embedding, and report generation, the presently described system provides a robust and efficient solution for leak detection and repair. This comprehensive approach minimizes human error, enhances data consistency, and streamlines LDAR workflows.

According to various embodiments, AI-based algorithms, ML-based algorithms, and/or other video enhancement algorithms may be utilized to stabilize captured video, normalize captured video, extract clips from a video stream, and/or otherwise facilitate consistency in the various segmented and annotated video clips provided by the incident reporting subsystem.

A possible workflow using the systems and methods described above may include, for example, a pilot initiating a drone inspection of a pipeline for transporting gas, a gas storage facility, a gas processing facility, or other gas infrastructure. The pilot may manually control the drone and camera positioning during the drone inspection flight. The pilot may observe a gas leak in the real-time video feed provided by the drone during the drone inspection flight and initiate an annotation process. The incident reporting system may initiate a flat-field correction (FFC) and/or a NUC process to capture an annotated video clip of the gas leak event. During the annotated video clip capture, the drone may temporarily disable manual human control.

The incident reporting system causes the drone to automatically fly and capture a video clip of the gas leak event according to a set of capture parameters (e.g., duration, position, proximity, panning effects, rotating effects, height, angles, exposure levels, etc.) defined for consistency in annotated video clip capture. Once the annotated video clip of the gas leak event is captured, control of the drone is reverted to the human operator. The human operator may subsequently identify a second gas leak and initiate the process to capture a second annotated video clip of the second gas leak event. The first and second annotated video clips of the first and second gas leak events share a high level of consistency to facilitate uniform analysis, comparison, and reporting.

As an example, the drone inspection flight may have a total duration of 35 minutes and include four gas leak detection events. Once the flight is completed, the 35-minute video capture may be processed by a report generation subsystem. The report generation subsystem may extract the four gas leak detection events. For example, each of the four gas leaks may be extracted and associated with a separate file containing a segmented and annotated five-second video clip of the respective gas leak. The four files contain a relatively small amount of data (e.g., have a relatively small file size) compared to the video recording of the entire 35-minute flight. The four segmented and annotated video clips, including the actionable data associated with each video clip, may be exported (e.g., via an API) into the existing LDAR software of the user or customer.

The presently described systems and methods may be expanded and adapted for use with human-manned aerial vehicles, such as helicopters. For example, instead of taking control of the entire helicopter, the incident reporting system may direct the human pilot to remain stationary or otherwise direct the human pilot to fly to a certain location in a certain flight pattern. The incident reporting system may control the camera system to capture a segmented and/or annotated video clip according to a set of parameters shared by other captured segmented and/or annotated video clips for subsequent analysis, comparison, and reporting. Thus, some of the systems, methods, and devices described herein are applicable to not only drones and UAVs, but may also be implemented wholly or partially in the context of a wide variety of unmanned aircraft, manned aircraft, unmanned ground vehicles (UGVs), unmanned fixed installations (e.g., security cameras), and/or handheld devices and systems.

According to various embodiments, the drone or other UAV may include a laser-based hydrocarbon detection system to detect, for example, methane gas. The laser-based gas detection system may be used for the automatic detection of gas leak events and/or for coloring or otherwise highlighting the location of leaking gas within a captured video feed (e.g., within an infrared video feed or within a visible light video feed). For example, infrared imaging video feeds may utilize black-hot or white-hot image rendering to generate a grayscale video feed representative of the detected temperatures within the video feed. In other embodiments, infrared imaging video feeds may utilize red-hot and blue-cold image renderings to generate a false-color representation of the detected temperatures within the video feed. Other grayscale and false-color renderings are possible. The laser-based gas detection system may be utilized to identify the location of specific gas types within each captured frame or set of frames of an infrared (or visible light) video feed. The specific gas type may be rendered within the video feed using a specific color, highlighting, or other visual indication to facilitate identification of the gas within the video feed.

According to various embodiments, the imaging system on the drone or other UAV may include visible light imaging sensors, thermal (IR) imaging sensors, lidar imaging, sonar imaging sensors, and/or laser-based gas detection subsystems. Any combination of sensors or imaging devices may be used to detect, image, and/or distinguish between ambient gases (e.g., air), terrain and infrastructure, and/or one or more types of target gases for detection. Examples of gases (or other fluids) for leak detection include but are not limited to acetic acid, ammonia, benzene, butadiene, butane, ethane, ethylbenzene, ethylene, heptane, hexane, isoprene, methyl ethyl ketone (MEK), methane, methanol, MIBK, octane, 1-pentane, propane, propylene, sulfur dioxide, toluene, vinyl chloride, xylene, and the like. In some embodiments, the sensor of one or more imaging and/or detection devices may be actively cooled.

In some embodiments, the variously described gas imaging and detection systems may be mounted on and/or used in conjunction with devices and systems other than drones or UAVs. For example, embodiments of the gas imaging and reporting system may be implemented as a handheld optical gas imaging (OGI) camera, allowing for portable gas detection and leak analysis in industrial, field, or confined-space environments. In other embodiments, the gas imaging system may be ground-mounted as a fixed installation, continuously monitoring gas emissions at refineries, storage facilities, pipelines, or high-risk infrastructure sites. Additionally, the system may be integrated into manned aerial vehicles, such as helicopters or fixed-wing aircraft, to conduct large-scale gas detection surveys over extensive geographic areas. The system may also be deployed on unmanned ground vehicles (UGVs) to autonomously navigate industrial sites, pipelines, or hazardous areas.

Regardless of the platform, the system may capture gas leak data, annotate detected leakage events, embed metadata (e.g., GPS coordinates, timestamps, wind conditions), and generate structured incident reports compatible with leak detection and repair (LDAR) workflows. The reporting system components may be integrated into the same device as the imaging system, be implemented remotely via a remote computing system, and/or implemented in part via a remote computing system. According to various embodiments, the systems and methods described herein may be implemented via instructions stored within a non-transitory computer-readable medium. The instructions may be functionally or actually organized in different modules and, when executed by a processor of a computing device, cause the computing device to perform the operations described herein.

In various examples, the system may include a non-transitory, computer-readable medium for storing instructions. The system may store the instructions in memory, and a processor may implement various modules to accomplish calculations and tasks performed by the system. Some of the infrastructure that can be used with embodiments disclosed herein is already available, such as general-purpose computers, computer programming tools and techniques, digital storage media, and communications networks. A computer may include a processor, such as a microprocessor, microcontroller, logic circuitry, or the like. The processor may include a special-purpose processing device, such as an ASIC, a PAL, a PLA, a PLD, a CPLD, an FPGA, or another customized or programmable device. The computer may also include a computer-readable storage device, such as non-volatile memory, static RAM, dynamic RAM, ROM, CD-ROM, disk, tape, magnetic memory, optical memory, flash memory, or another computer-readable storage medium.

Suitable networks for configuration and/or use, as described herein, include any of a wide variety of network infrastructures. A network may incorporate landlines, wireless communication, optical connections, various modulators, demodulators, small form-factor pluggable (SFP) transceivers, routers, hubs, switches, and/or other networking equipment. The network may include communications or networking software and may operate using TCP/IP, SPX, IPX, SONET, and other protocols over twisted pair, coaxial, or optical fiber cables, telephone lines, satellites, microwave relays, modulated AC power lines, physical media transfer, wireless radio links, and/or other wireless or wired data transmission types. The network may encompass smaller networks and/or be connectable to other networks through a gateway or similar mechanism.

Aspects of certain embodiments described herein may be implemented as software modules or components. As used herein, a software module or component may include any type of computer instruction or computer-executable code located within or on a computer-readable storage medium, such as a non-transitory, computer-readable medium. A software module may, for instance, comprise one or more physical or logical blocks of computer instructions, which may be organized as a routine, program, object, component, data structure, etc., that perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Further, those of skill in the art will recognize that one or more of the specific details may be omitted, or other methods, components, or materials may be used. In some cases, operations are not shown or described in detail. Thus, the following detailed description of the embodiments of the systems and methods of the disclosure is not intended to limit the scope of the disclosure, as claimed, but is merely representative of possible embodiments.

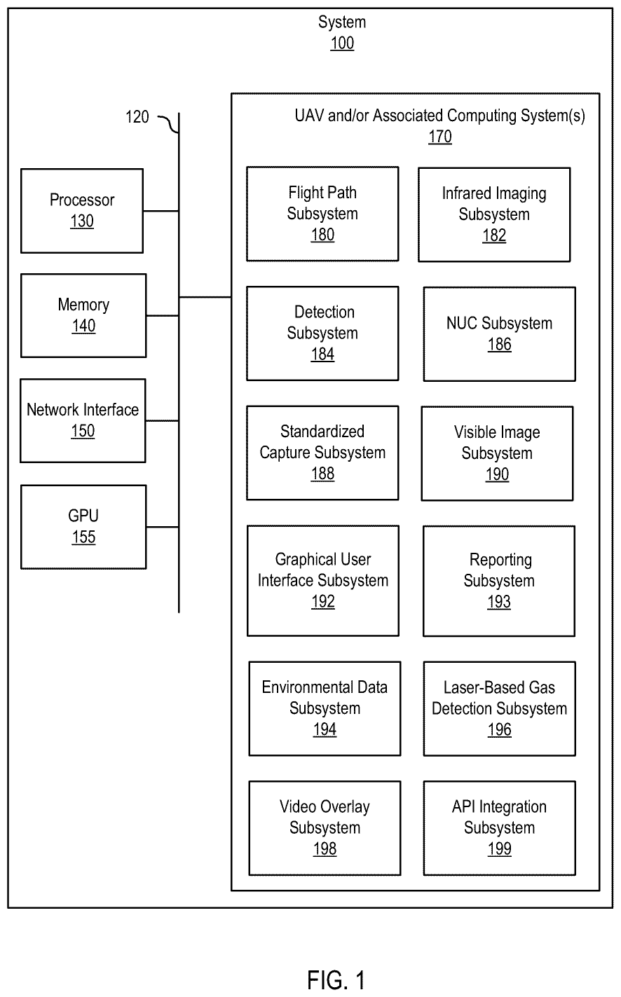

FIG. 1 illustrates a block diagram of an example detection system 100, according to one embodiment. The detection system 100 may be configured to detect and report gas leaks using an unmanned aerial vehicle (UAV) and associated computing resources. System 100 comprises a bus 120 that connects a processor 130, memory 140, network interface 150, and a GPU 155 to various subsystems that part of a UAV computing system and/or remote computing system(s) 170. The various computing systems, whether stored onboard the UAV or remotely, collectively enable real-time gas leak detection, video processing, environmental data collection, and automated incident reporting.

The computing systems 170 includes key hardware components that support UAV operations and data processing. The processor 130 executes gas detection algorithms, video processing, and flight control functions. The memory 140 stores video data, processing instructions, and metadata associated with detected gas leaks. The network Interface 150 facilitates data transmission between the UAV and remote computing systems, including, for example, cloud-based leak detection and repair (LDAR) systems. The GPU 155 accelerates real-time processing of video feeds, including infrared and visible light imaging, to improve efficiency in gas leak detection and annotation.

The computing systems 170 includes multiple subsystems that collectively enable gas leak detection, standardized video capture, environmental data collection, and automated reporting. The flight path subsystem 180 controls UAV navigation and flight path adjustments, including autonomous positioning in response to detected gas leaks. The infrared imaging subsystem 182 captures thermal imaging data to identify potential gas leaks based on temperature differentials. The detection subsystem 184 processes captured video data to detect gas leakage events. In some embodiments, the detection subsystem 184 may utilize artificial intelligence (AI) or machine learning (ML)-based algorithms. The NUC subsystem 186 performs non-uniformity correction (NUC) on captured video. For example, the NUC subsystem 186 may implement flat-field correction (FFC) to eliminate image inconsistencies.

The standardized capture subsystem 188 ensures that imaging parameters, such as frame rate, exposure, gain settings, and focal length, remain consistent across all gas leak video clips captured during a detected event. The visible image subsystem 190 captures visual light images that complement infrared video feeds. The visible light images may be useful to provide visual context and/or facilitate enhanced verification of gas leaks. The graphical user interface subsystem 192 provides an interface for human operators to monitor real-time video feeds, receive alerts, and/or manually annotate gas leak events when necessary. The reporting subsystem 193 processes detected gas leaks, extracts relevant video clips, embeds metadata, formats incident reports, and/or transmits them to external LDAR management systems. The reporting subsystem 193 may ensure compatibility with specific application programming interfaces (APIs).

In some embodiments, the system may include an environmental Data Subsystem 194 that collects environmental parameters such as wind speed, air temperature, and/or atmospheric pressure at the time of the gas leakage event. In various embodiments, this metadata is embedded into video annotations for improved leak characterization. In some embodiments, a laser-based gas detection subsystem 196 incorporates laser-based sensing technology to identify specific gas types within the leak site. In some embodiments, the system may include a video overlay subsystem 198 that processes and overlays gas concentration data onto the captured video feed, ensuring precise visualization of detected leaks.

As described herein, the system may integrate with external LDAR workflows via an API integration subsystem 199. The API integration subsystem 199 may facilitate secure communication with third-party gas leak detection and reporting platforms. The reporting subsystem may transmit incident reports using encrypted communication protocols to ensure data integrity and regulatory compliance.

As described herein, the flight path subsystem 180 and standardized capture subsystem 188 allow for autonomous UAV positioning, adjusting altitude and orientation relative to detected gas leaks to maintain standardized capture conditions. The system 100 provides a structural representation of the system's components, demonstrating how the UAV and associated computing subsystems work together to detect gas leaks, process captured data, collect environmental parameters, generate standardized reports, and/or integrate with LDAR workflows. These subsystems collectively implement the claimed features, ensuring an efficient, automated, and standardized approach to UAV-based gas leak detection and reporting.

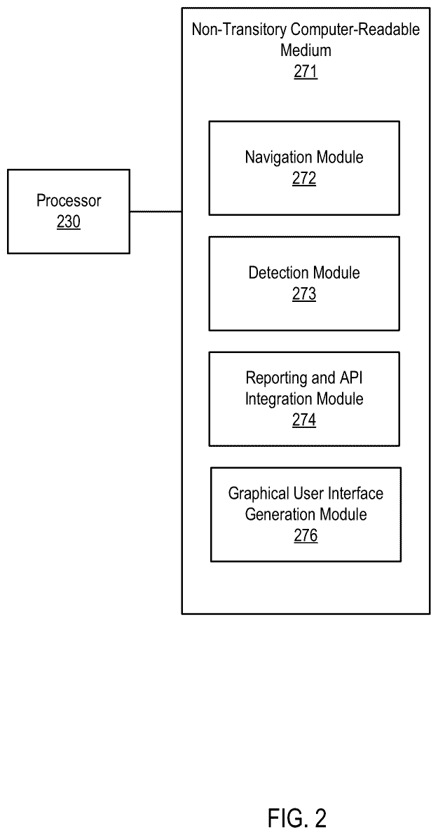

FIG. 2 illustrates a block diagram of portions a detection system that are implemented as computer-readable instructions, according to one embodiment. The example architecture includes a processor 230 communicatively coupled to a non-transitory computer-readable medium 271. The non-transitory computer-readable medium 271 may store computer-executable instructions that, when executed by the processor 230, cause the processor to perform various functions related to UAV-based gas leak detection, navigation, reporting, and/or user interaction.

The non-transitory computer-readable medium 271 includes a navigation module 272 that may control UAV movement, including autonomous and manual navigation. The navigation module 272 may implement flight path adjustments based on detected gas leaks or predefined survey routes. The detection module 273 may be configured to process sensor data from infrared imaging systems, laser-based gas detection systems, and other onboard or external sensing components to detect gas leakage events. The detection module 273 may apply artificial intelligence (AI) or machine learning (ML) algorithms to enhance detection accuracy and reduce false positives.

The reporting and API integration module 274 may be configured to generate incident reports based on detected gas leakage events. The reporting and API integration module 274 may extract relevant video segments, embed metadata, and format reports for transmission to external leak detection and repair (LDAR) systems. The module may also support secure data transmission via encrypted communication protocols to ensure regulatory compliance and data integrity. The graphical user interface generation module 276 may be configured to generate a user interface for displaying gas leak detection results, real-time UAV telemetry data, and system status information. The graphical user interface generation module 276 may allow operators to monitor UAV operations, receive alerts, and interact with detection and reporting functionalities.

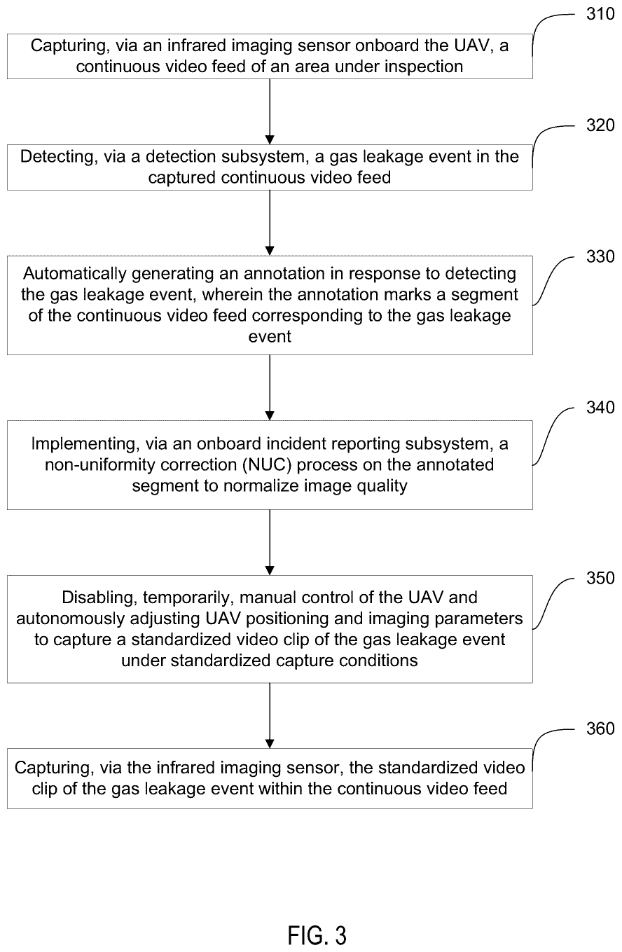

FIG. 3 illustrates a flow chart of a method for detecting a gas leak and segmenting, annotating, and normalizing captured video for standardized reporting, according to one embodiment. As illustrated, the UAV may operate by capturing, at 310, a continuous video feed of an area under inspection. For example, the UAV may capture the continuous video feed using an infrared imaging sensor and/or a visible spectrum imaging sensor. The UAV may be manually operated by a user during the initial area under inspection. The UAV may, in some embodiments, include a laser-base gas leak detection subsystem, as described herein. The UAV may detect, at 320, (e.g., via a detection subsystem) a gas leakage event in the captured continuous video feed. The detection subsystem may analyze the captured infrared imaging data to identify gas movement indicative of a leak. In some embodiments, the detection subsystem may utilize artificial intelligence (AI) or machine learning (ML) algorithms to distinguish between gas leaks and environmental artifacts. In some embodiments, the detection subsystem may include a laser-based gas detection system configured to detect specific gas types.

The UAV may automatically generate, at 330, an annotation in response to detecting the gas leakage event. The annotation marks a segment of the continuous video feed corresponding to the gas leakage event. The annotation may serve as a time-based marker within the continuous video feed to indicate the occurrence of the detected leak. In some embodiments, the annotation may be associated with additional metadata, such as location coordinates, environmental conditions, and leak classification data.

The UAV may implement, at 340, (e.g., via an onboard incident reporting subsystem) a non-uniformity correction (NUC) process on the annotated segment to normalize image quality. The NUC process may include applying a flat-field correction (FFC) to improve the uniformity of the captured infrared imaging data. In some embodiments, the NUC process may reduce noise and temperature-dependent image artifacts to ensure consistency in recorded video clips of detected gas leaks.

The UAV may disable, at 350, temporarily, manual control and autonomously adjust UAV positioning and imaging parameters to capture a standardized video clip of the gas leakage event under standardized capture conditions. The UAV may adjust its altitude, orientation, and camera angles based on predefined flight patterns or real-time analysis of the detected leak location. In some embodiments, the imaging parameters may include frame rate, exposure settings, gain levels, and focal length adjustments to maintain consistency across recorded gas leak events.

The UAV may capture, at 360, (e.g., via the infrared imaging sensor) the standardized video clip of the gas leakage event within the continuous video feed. The standardized video clip may be recorded with a predefined duration and resolution to facilitate uniform reporting. In some embodiments, the video clip may be stored locally on the UAV, transmitted to a remote computing system, or processed immediately for integration into a leak detection and repair (LDAR) workflow.

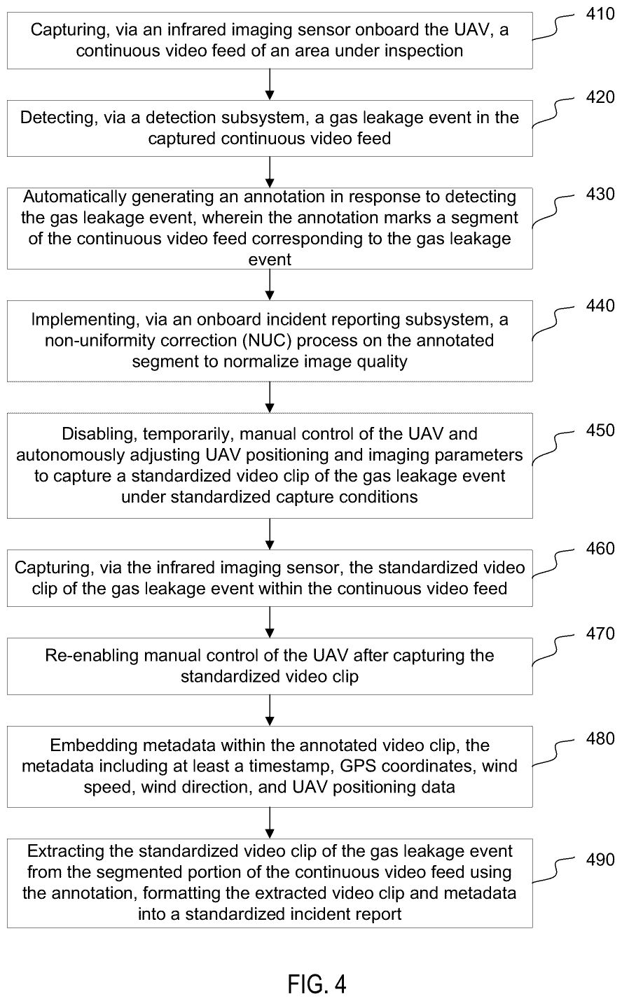

FIG. 4 illustrates another flow chart of a method for detecting a gas leak and segmenting, annotating, and normalizing captured video for standardized reporting, according to one embodiment. The UAV may capture, at 410, (e.g., via an infrared imaging sensor onboard the UAV) a continuous video feed of an area under inspection. The infrared imaging sensor may detect variations in thermal radiation to identify potential gas leaks. In some embodiments, the infrared imaging sensor may be configured to operate at specific wavelengths optimized for detecting hydrocarbon-based gases. In some embodiments, the infrared imaging sensor may be integrated with a visible light imaging system to provide additional context for captured video feeds.

The UAV may detect, at 420, (e.g., via a detection subsystem) a gas leakage event in the captured continuous video feed. The detection subsystem may analyze the captured infrared imaging data to identify gas movement indicative of a leak. In some embodiments, the detection subsystem may utilize artificial intelligence (AI) or machine learning (ML) algorithms to distinguish between gas leaks and environmental artifacts. For example, AI-based algorithms may be trained using historical infrared imaging datasets to recognize specific gas dispersion patterns. The algorithms may be trained to minimize false positives caused by environmental factors such as heat differentials or atmospheric turbulence. In some embodiments, the detection subsystem may include a laser-based gas detection system configured to detect specific gas types. The laser-based detection system may emit a scanning laser at a predetermined wavelength and measure absorption characteristics to determine the presence and concentration of hydrocarbon-based gases.

In some embodiments, the detection subsystem may operate in conjunction with a visible imaging subsystem to provide additional visual confirmation of a detected gas leakage event. The combined infrared and visible imaging data may improve detection accuracy by allowing the system to differentiate between gas leaks and background thermal noise. Additionally, the detection subsystem may integrate real-time environmental data from onboard sensors, including wind speed, temperature, and humidity, to refine its gas leak detection models. For example, wind direction and speed may influence the dispersion of leaked gas, and the detection subsystem may account for these factors to improve the accuracy of detected leak locations.

In some embodiments, the detection subsystem may be configured to operate in either an autonomous mode or a manual operator-assisted mode. In autonomous mode, the subsystem continuously scans the infrared imaging feed and automatically identifies potential gas leaks without human intervention. In manual operator-assisted mode, the detection subsystem may highlight potential leak locations within the video feed and prompt an operator for verification before triggering an annotation event. In some implementations, the detection subsystem may generate a confidence score for each detected gas leak, providing a quantitative assessment of detection reliability.

In some embodiments, the detection subsystem may be configured to detect multiple gas leakage events within a single flight session. For example, if multiple leaks are present within an inspection area, the detection subsystem may prioritize and annotate each leak individually based on factors such as gas concentration, proximity to critical infrastructure, and estimated leak severity. The detection subsystem may also integrate with an LDAR (leak detection and repair) workflow, where detected leaks are automatically assigned priority levels for subsequent repair actions.

In some implementations, the detection subsystem may be configured to apply dynamic adjustments to UAV positioning in response to a detected gas leakage event. For example, upon identifying a potential leak, the system may trigger an autonomous flight adjustment sequence, wherein the UAV repositions itself to capture additional imaging data at optimized and/or standardized angles and distances. The detection subsystem may further generate an incident flag, marking the detected leak for further analysis, annotation, and reporting.

The UAV may automatically generate, at 430, an annotation in response to detecting the gas leakage event, wherein the annotation marks a segment of the continuous video feed corresponding to the gas leakage event. The annotation may serve as a time-based marker within the continuous video feed to indicate the occurrence of the detected leak. In some embodiments, the annotation may be associated with additional metadata, such as location coordinates, environmental conditions, and leak classification data.

In some implementations, the system may include a capture function that enables automatic recording of gas leakage events based on detection triggers. The capture function may be configured to store high-resolution video segments of detected gas leaks, ensuring that operators and analysts can review and analyze the recorded events post-flight. In some embodiments, the capture function may be initiated manually by an operator and/or automatically based on AI-based detection models.

The system may also support manual flight recording for extended durations, such as a 30-minute continuous video session. During a recording session, an operator may manually navigate the UAV over an inspection area to, for example, capture video footage of gas pipelines, storage tanks, industrial sites, or the like. After completing the flight, the recorded footage may be processed by the reporting subsystem to detect gas leaks, extract relevant segments, and generate a structured report. For example, if the UAV detects seven individual gas leaks during the flight, the system may analyze the recorded video, segment the relevant portions, and compile them into a structured incident report.

To improve efficiency and standardization, the system may automate the annotation process. Human operators may struggle to manually annotate long-duration video recordings, making it impractical for large-scale industrial inspections. The reporting subsystem may automatically segment the footage, annotate detected gas leaks, and organize the results into a structured format for review.

The structured output directory and consolidated HTML report may be configured to support data synchronization with satellite-based networks, such as the Iridium network. This integration enables remote access to gas leak incident reports, even in geographically isolated locations where terrestrial network connectivity is unavailable. In some embodiments, operators or regulatory agencies may retrieve gas leak incident data via a satellite uplink.

Additionally, the reporting subsystem may utilize infrared core data in conjunction with standard imaging sensors to enhance post-processing analysis. The system may compare different infrared imaging datasets to refine detection accuracy, reduce false positives, and improve the reliability of reported gas leaks. The reporting tool may also incorporate AI-based learning models to continuously improve detection accuracy based on historical gas leak incidents.

The UAV may implement, at 440, (e.g., via an onboard incident reporting subsystem) a non-uniformity correction (NUC) process on the annotated segment to normalize image quality. The NUC process may include applying a flat-field correction (FFC) to improve the uniformity of the captured infrared imaging data. The FFC process may compensate for variations in sensor response across the infrared imaging array by periodically capturing a reference frame against a uniform temperature source and applying a correction matrix to subsequent frames. In some embodiments, the NUC process may reduce noise and temperature-dependent image artifacts to ensure consistency in recorded video clips of detected gas leaks.

In some embodiments, the NUC process may be triggered automatically upon detecting a gas leakage event to ensure that the captured segment maintains a standardized visual quality. The NUC subsystem may adjust infrared sensor calibration parameters in real-time. Examples of settings and calibration parameters include, but are not limited to gain control, offset correction, and pixel-level compensation. For example, the system may detect sensor drift caused by prolonged exposure to varying thermal conditions and dynamically recalibrate the imaging sensor to maintain accurate leak visualization.

In some embodiments, the NUC process may be adaptive and operate to analyze image consistency and apply targeted corrections based on environmental conditions. In some embodiments, the NUC process may be performed in conjunction with multi-spectral image fusion. The multi-spectral image fusion may correct or modify the infrared imaging data based on overlaid visible spectrum imagery from the UAV's visible image subsystem. Multi-spectral image fusion may enhance leak visualization and/or detection by providing contextual information about the surrounding environment (e.g., pipeline structures, terrain features, or other reference objects).

Accordingly, the NUC subsystem may work alongside the video overlay subsystem to ensure that corrected video segments maintain a standardized format suitable for reporting and integration into LDAR workflows. The corrected video segments may be encoded with metadata, including timestamps, GPS coordinates, and/or sensor calibration parameters. In some embodiments, raw data may be provided as well.

The UAV may disable, at 450, temporarily, manual control and autonomously adjust UAV positioning and imaging parameters to capture a standardized video clip of the gas leakage event under standardized capture conditions. The UAV may adjust its altitude, orientation, and camera angles based on predefined flight patterns or real-time analysis of the detected leak location. In some embodiments, the imaging parameters may include frame rate, exposure settings, gain levels, and/or focal length adjustments to maintain consistency across recorded gas leak events.

The UAV may capture, at 460, (e.g., via the infrared imaging sensor) the standardized video clip of the gas leakage event within the continuous video feed. The standardized video clip may be recorded with a predefined duration and resolution to facilitate uniform reporting. In some embodiments, the video clip may be stored locally on the UAV, transmitted to a remote computing system, or processed immediately for integration into a leak detection and repair (LDAR) workflow.

The UAV may re-enable, at 470, manual control after capturing the standardized video clip. The system may allow the operator to resume manual flight control or continue in an autonomous flight mode for additional inspection. In some embodiments, the system may provide real-time feedback to the operator regarding the successful capture of the video clip.

The UAV may embed, at 480, metadata within the annotated video clip, the metadata including at least a timestamp, GPS coordinates, wind speed, wind direction, and/or UAV positioning data. The metadata may assist in the classification and tracking of detected gas leaks for reporting and regulatory compliance. In some embodiments, the metadata may also include environmental parameters such as temperature, humidity, and/or atmospheric pressure.

The UAV may extract, at 490, the standardized video clip of the gas leakage event from the segmented portion of the continuous video feed using the annotation, formatting the extracted video clip and metadata into a standardized incident report. In various embodiments, the standardized incident report may include a map showing the location of one or more of the detected leakage events. The report may be structured for compatibility with one or more third-party LDAR systems and regulatory frameworks. In some embodiments, the report may be transmitted to a remote server or cloud-based platform for further analysis, storage, or automated response generation.

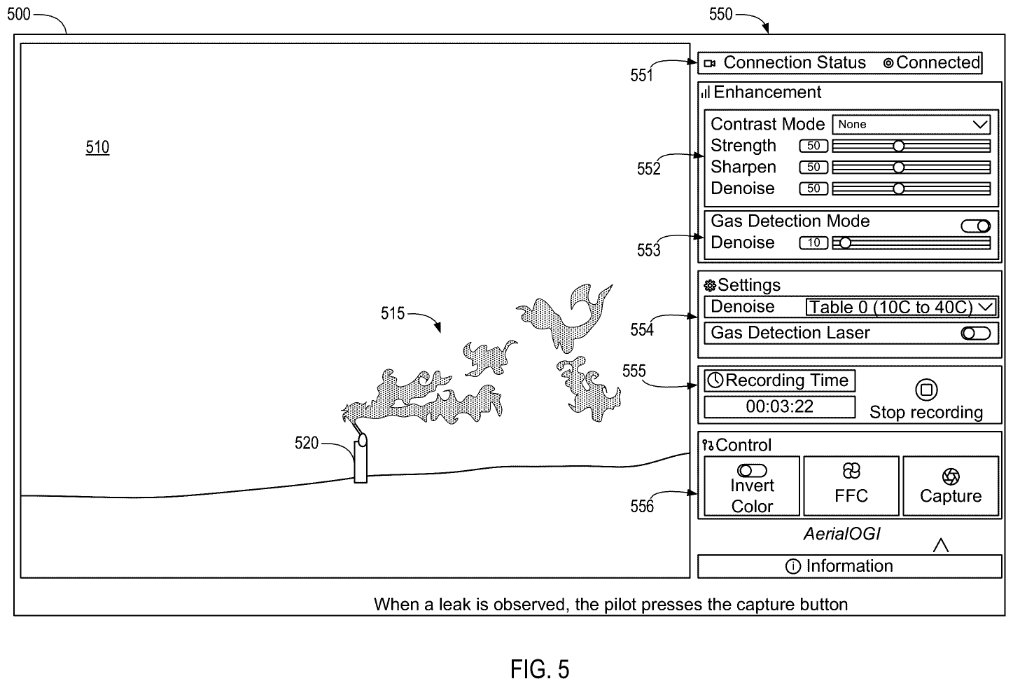

Some portions of FIGS. 5-11C are based on screenshots in which color images and/or false color representations are used to facilitate an improved understanding of the functionality of the presently described systems and methods. Color versions of the screenshots, which are available in the provisional patent application to which this application claims priority (which has been fully incorporated by reference), may be useful to facilitate a complete or improved understanding of the presently described systems and methods.

FIG. 5 illustrates a screenshot 500 of a live video feed 510 from a drone with a control interface and a detected leak 515 shown in a gas detection mode (GDM mode), according to one embodiment. As illustrated, when a gas leak 515 is observed by the operator and/or identified by an AI-based or ML-based detection subsystem, the operator may (or the system may automatically) begin recording a normalized video segment. Since the drone video feed 510 may already be recorded in its entirety, the “event recording” may actually include annotating the beginning and end points of a segment of the video to be included as part of a normalized or standardized video clip of the detected/identified gas leakage event.

In some embodiments, the gas detection mode may process the infrared video feed using spectral filtering techniques to enhance the visibility of hydrocarbon-based gases. The enhancement may include rendering the detected gas plume in a specific color overlay or adjusting the contrast dynamically based on gas concentration levels. The detected gas leak may be visualized in real-time with motion tracking, allowing operators to assess gas dispersion patterns and adjust flight positioning accordingly.

As illustrated, the interface includes a control panel 550 with various settings and controls. In the illustrated example, the control panel 550 includes a connection status indicator 551 and a video parameters 552 for contrast, strength, sharpening, and denoising. The control panel 550 also includes a gas detection mode (GDM) selector 553 with a denoising option. The control panel 550 also includes settings 554 for denoising and enabling a gas detection laser. In some embodiments, the gas detection laser may function as an active scanning system, utilizing a tuned infrared laser to detect specific gas types based on their absorption spectra. The system may overlay laser-based detection data onto the live feed to provide additional confirmation of gas leakage events.

A recording function 555 is also illustrated, along with various camera control options 556 for inverting the color, performing a flat-field correction (FFC) calibration to ensure non-uniformity correction, and initiating a still image capture of the detected gas leak event. The still image capture function may store a high-resolution snapshot of the gas leak with embedded metadata, including GPS location, altitude, wind conditions, and leak classification parameters.

In some embodiments, the control panel may dynamically adjust interface elements based on the UAV's operational mode. For example, when an automatic gas detection event is triggered, the recording function may activate automatically, and additional data overlays, such as wind direction indicators and gas concentration levels, may be displayed on the live feed. The operator may also have the option to apply real-time image processing enhancements, including thermal contrast optimization and motion compensation, to improve visibility under varying environmental conditions.

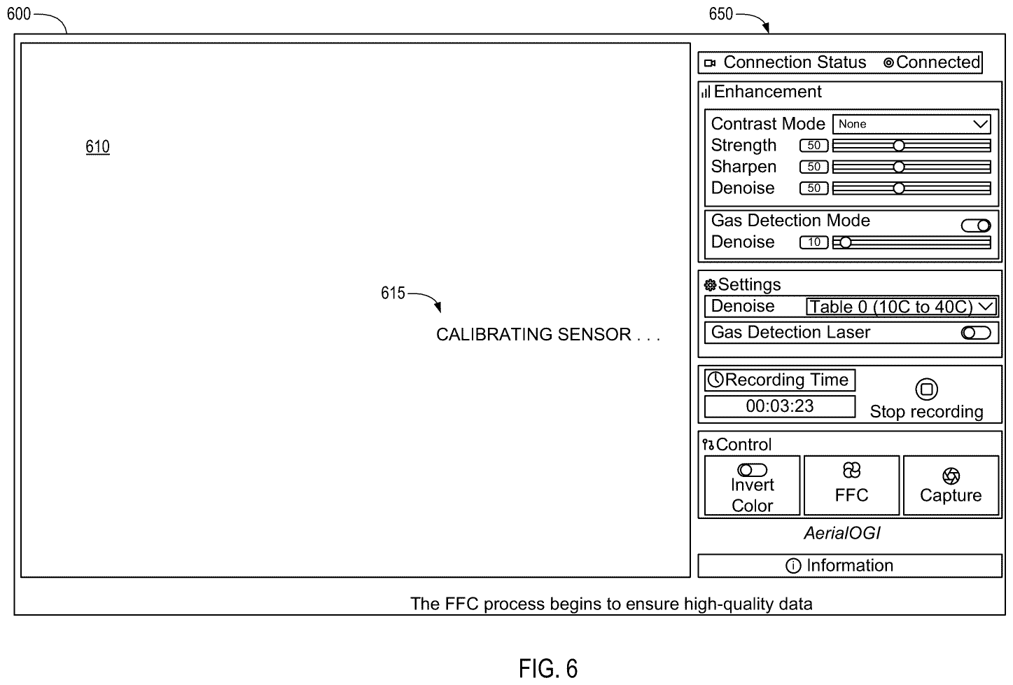

FIG. 6 illustrates a screenshot 600 of a video feed 610 from a drone during the application of a non-uniformity correction (NUC) mode applying a flat-field correction (FFC), according to one embodiment. The sensor calibration may be initiated via an option within the control panel 650. Before the video clip segment is started (e.g., the beginning point is marked or annotated), the imaging system may perform a NUC adjustment (e.g., including an FFC) to ensure high-quality and standardized data is captured in the video clip of the gas leakage event.

As illustrated, a calibration message 615 is displayed in the video feed 610, indicating that the imaging sensor is undergoing the FFC process. The FFC process may be triggered automatically at predefined intervals or manually initiated by an operator via the control panel 650. In some embodiments, the system may prompt the operator to confirm the calibration process before proceeding with video capture.

During FFC calibration, the imaging system may temporarily pause normal video feed processing and adjust sensor parameters to compensate for pixel-level variations across the infrared detector array. The system may capture a reference frame against an internal or external uniform temperature source and use this reference to correct subsequent frames. This process helps mitigate fixed pattern noise, sensor drift, and thermal inconsistencies that may otherwise impact the accuracy of gas leak visualization.

Once the calibration process is complete, the system may automatically resume live video feed processing and gas leak detection operations. The operator may proceed with capturing standardized video clips, embedding metadata, and integrating the recorded footage into a leak detection and repair (LDAR) workflow.

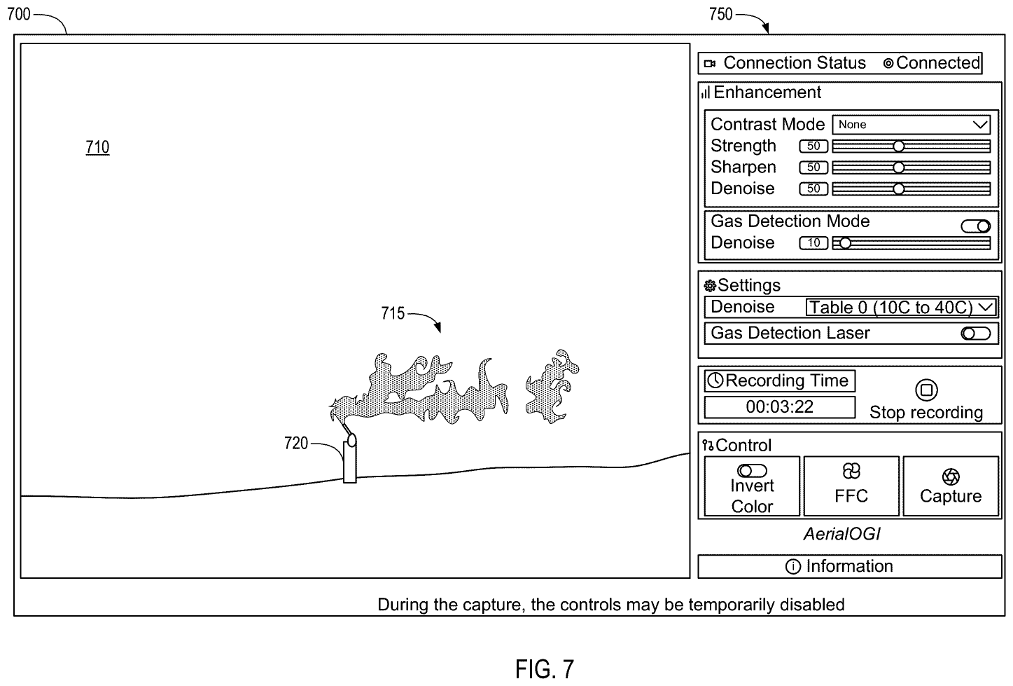

FIG. 7 illustrates a screenshot 700 of a video feed 710 from a drone with the manual controls disabled during a video annotation and automatic capture of a detected gas leakage event, according to one embodiment. In the illustrated example, gas leakage 715 is detected from a pipe 720. The gas leakage 715 is visualized in an enhanced mode, where the detected gas plume is overlaid onto the infrared video feed to improve visibility and analysis. The detected leak may be identified using AI-based or ML-based detection techniques, or it may be confirmed manually by an operator before initiating the automatic capture sequence.

In some embodiments, only some or none of the controls within the control panel 750 may be accessible during the automatic capture process. The system may temporarily disable operator inputs related to flight navigation, camera positioning, and image processing to ensure that the video capture process is performed under standardized conditions. The control panel 750 may display a notification indicating that the UAV is in autonomous capture mode, preventing manual overrides until the recording is complete.

The drone may be automatically piloted, and/or the imaging sensors may be automatically controlled (e.g., direction controlled, exposure controlled, shutter speed controlled, frame rate controlled, sensitivity controlled, aperture controlled, etc.) to ensure that each captured video clip of each distinct gas leakage event is captured in a uniform manner to facilitate comparisons. In some embodiments, the UAV may adjust its altitude, angle, and flight path dynamically in response to the detected gas leak. Each captured video clip of each detected leakage event may be captured with a recorded video segments that maintains consistent framing, resolution, and sensor parameters.

The UAV may apply real-time image corrections, including non-uniformity correction (NUC) and flat-field correction (FFC), to enhance the quality of the captured video feed. The system may also adjust contrast levels and/or apply gas detection overlays to improve the visibility of the leakage event 715.

In some implementations, the UAV may store the video annotation metadata, including GPS coordinates, wind speed, environmental conditions, and UAV positioning data, within the video clip itself. This embedded metadata may facilitate subsequent analysis and integration into a leak detection and repair (LDAR) workflow. Once the video clip is recorded, the system may automatically re-enable manual controls, allowing the operator to resume manual navigation or continue monitoring additional gas leaks.

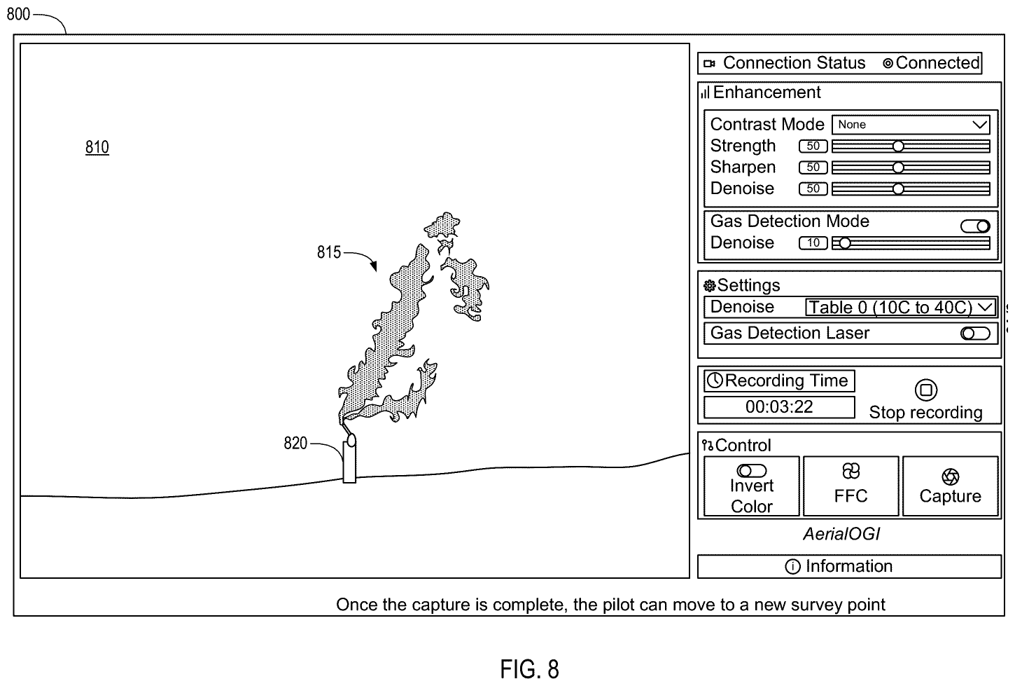

FIG. 8 illustrates a screenshot 800 of the video feed 810 from the drone with the manual controls enabled after the video annotation and automatic capture are completed, according to one embodiment. The video clip may comprise annotations or metadata identifying beginning and end points within the continuously recorded video stream, in some embodiments. Thus, the video clip may correspond to a few seconds identified via the annotations during which the automatic controls ensure a uniform video clip capture of the gas leakage event. After the video clip is captured and/or annotated, manual control is returned to the operator of the drone. In the illustrated example, the video feed 810 shows the same pipe 820 and gas leakage event 815, but with different wind parameters that change the shape of the detected gas leakage event 815.

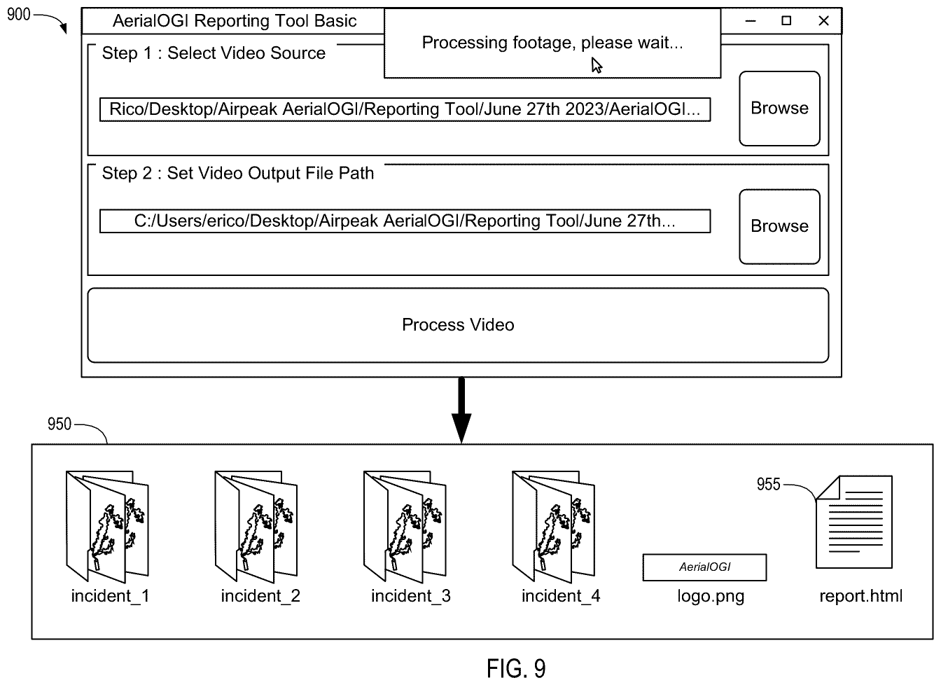

FIG. 9 illustrates a screenshot of a reporting tool interface 900 and block diagram of a structured output file 950 of a complete video file being processed by a reporting subsystem to extract and generate individual segmented and annotated video clips of each detected gas leakage event, according to one embodiment. After the flight is completed, the complete video file of the entire flight may be downloaded to a computer or other processing device. A reporting subsystem, which may be implemented as hardware, firmware, and/or software executed by a processor, may extract and/or generate individual files 950 for each detected gas leakage event from a single video file. For example, annotations identifying the beginning and ending points of each automatically captured video clip of each detected gas leakage event may be used to generate the individual files. A single HTML report file 955 may be used to navigate and view the individual files.

As illustrated, the reporting tool interface 900 provides a step-by-step process for selecting a video source, defining an output file path, and initiating the video processing operation. The reporting tool may analyze the video file for embedded metadata, including timestamps, GPS coordinates, and environmental data, to ensure accurate segmentation of each detected gas leakage event. In some embodiments, the reporting tool may apply additional image processing techniques, such as frame stabilization and contrast enhancement, before finalizing the segmented video clips.

The processing engine may utilize AI-based or ML-based models to refine the segmentation process to, for example, ensure that only relevant portions of the video feed corresponding to confirmed gas leaks are extracted (in the standardized format). In some embodiments, the reporting tool may flag low-confidence detections and prompt an operator for manual verification before finalizing the segmented video clips.

Once the segmentation process is complete, the reporting subsystem may generate a structured output directory 950 containing individual folders for each detected gas leakage event, labeled as incident_1, incident_2, incident_3, and incident_4. Each folder may contain a combination of infrared video footage, visible spectrum images, and associated metadata files. In some implementations, additional data visualizations, such as gas dispersion heatmaps, may be included within each incident folder to provide further insight into the detected leaks.

The reporting subsystem may also generate a summary report 955 in an HTML format, allowing users to quickly navigate between individual incident recordings. The HTML report may include embedded video previews, incident timestamps, GPS location data, and a summary of environmental conditions during each leak detection event. The report may be configured for seamless integration (e.g., via an API) with external LDAR (leak detection and repair) management systems, enabling automated compliance tracking and incident review.

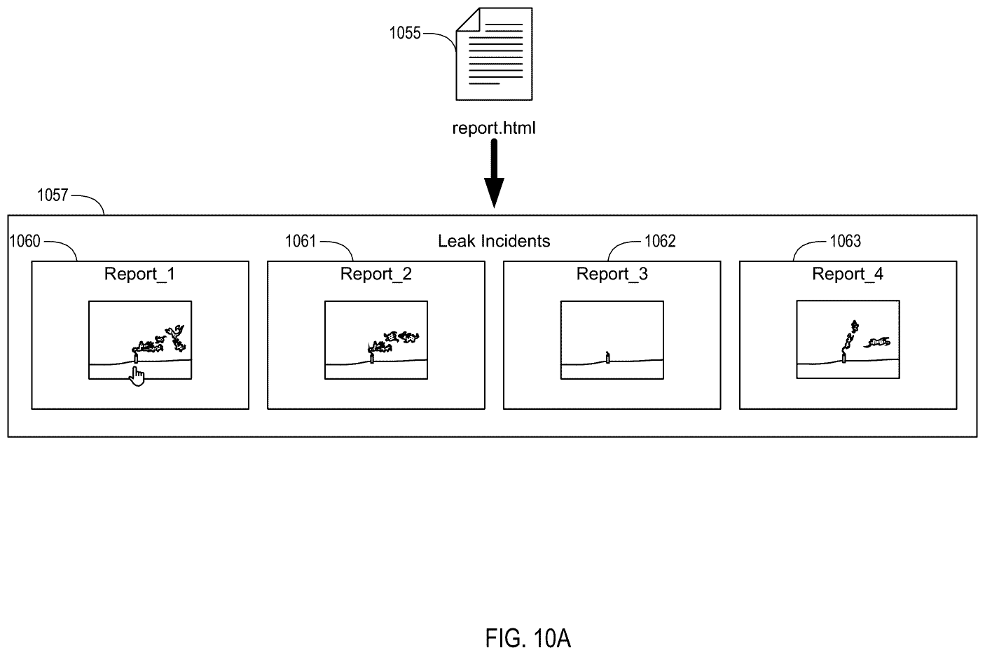

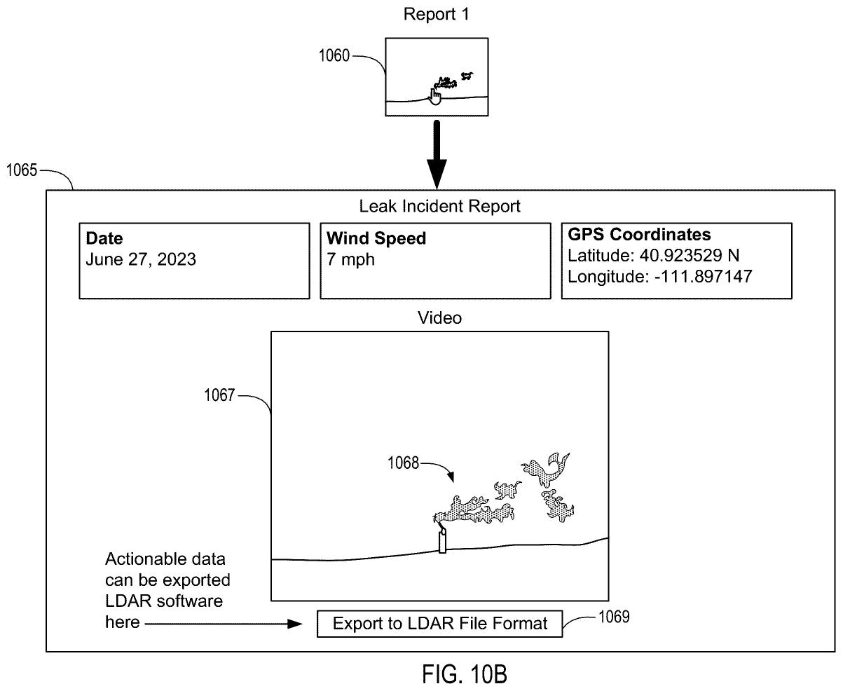

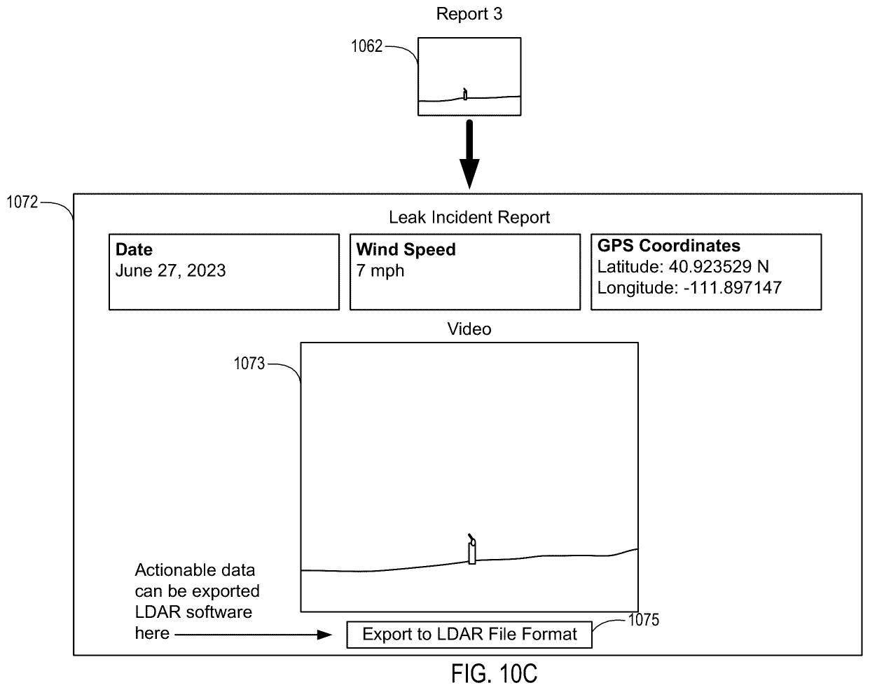

FIG. 10A illustrates a consolidated report 1055 in HTML format that allows for individual review of each of the segmented and annotated video clips of the detected gas leakage events, according to one embodiment. In the illustrated example, a structured output directory 1057 includes individual files 1060, 1061, 1062, and 1063 that correspond to four distinct gas leakage events for which segmented and annotated video clips have been generated with actionable data recorded for each event.

As shown, each file is labeled as “Report_1” 1060, “Report_2” 1061, “Report_3” 1062, and “Report_4” 1063, each of which represents an individual gas leak incident. Each report 1060-1063 contains a still frame extracted from the corresponding video segment, providing a preview of the detected gas leakage event. In some embodiments, these previews may be interactive, allowing users to click on each image to open the corresponding video clip for further review. The structured output directory 1057 may organize reports based on detection timestamps, severity levels, or geographic locations to facilitate efficient incident analysis and prioritization.

The consolidated HTML report 1055 may function as a user-friendly interface, enabling operators, analysts, or maintenance teams to quickly review detected leaks and associated metadata. In some embodiments, the consolidated report 1055 may include embedded playback controls, allowing users to stream the recorded video clips directly within the report interface without requiring additional software. The consolidated HTML report 1055 may also provide filtering options to sort or categorize detected leaks based on parameters such as gas concentration, wind speed, UAV altitude, and/or location at the time of detection.

In some implementations, the structured output directory 1057 may be generated dynamically by a reporting subsystem, ensuring that each detected gas leakage event is properly documented and stored in a standardized format. Each report 1060-1063 may contain additional metadata, such as GPS coordinates, environmental conditions, and detection confidence scores, which may be embedded directly into the consolidated HTML report 1055 or stored as separate data files for integration into external systems. The consolidated HTML report 1055 may also be formatted for compatibility with third-party leak detection and repair (LDAR) systems (e.g., to be shared or uploaded via an API).

FIG. 10B illustrates an example segmented and annotated video clip of a gas leakage event from the first report 1060, according to one embodiment. As illustrated, the video clip 1067 may include a GDM mode in which the leaking gas 1068 is illustrated in green (or another color or different visual emphasis). The leak incident report 1065 may include date and time information, wind speed information, and location information (e.g., elevation, height, angle, direction, yaw, tilt, rotation, GPS coordinates, etc.) The video clip 1067 and/or still images may be viewed. The video clip 1067 itself and/or any or all the actionable data associated with the video clip may be converted to a file format for transmission or injection into an LDAR system of the user or associated customer via an export option 1069.

FIG. 10C illustrates an example segmented and annotated video clip of another gas leakage event from the third report 1062, according to one embodiment. The leak incident report 1072 may include date and time information, wind speed information, and location information. The illustrated example includes a video clip 1073 with a black-hot color rendering of the thermal information captured by the drone. Additional data may be available, and/or higher-resolution images or video clips may be captured or stored during “event recordings” that are provided in the live-view feed and/or are recorded as part of the continuous flight recording. Again, an export option 1075 allows the data to be exported to an LDAR system.

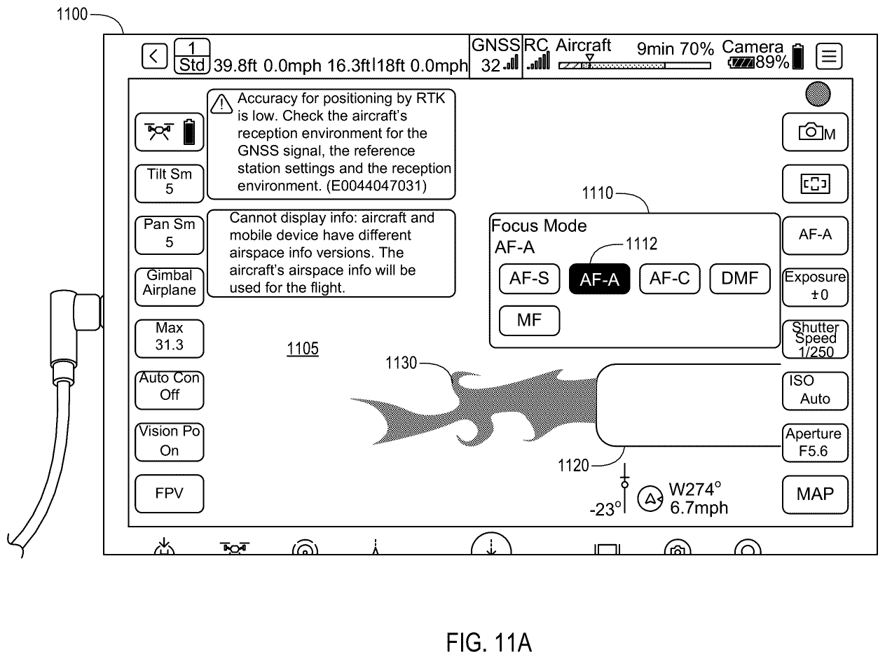

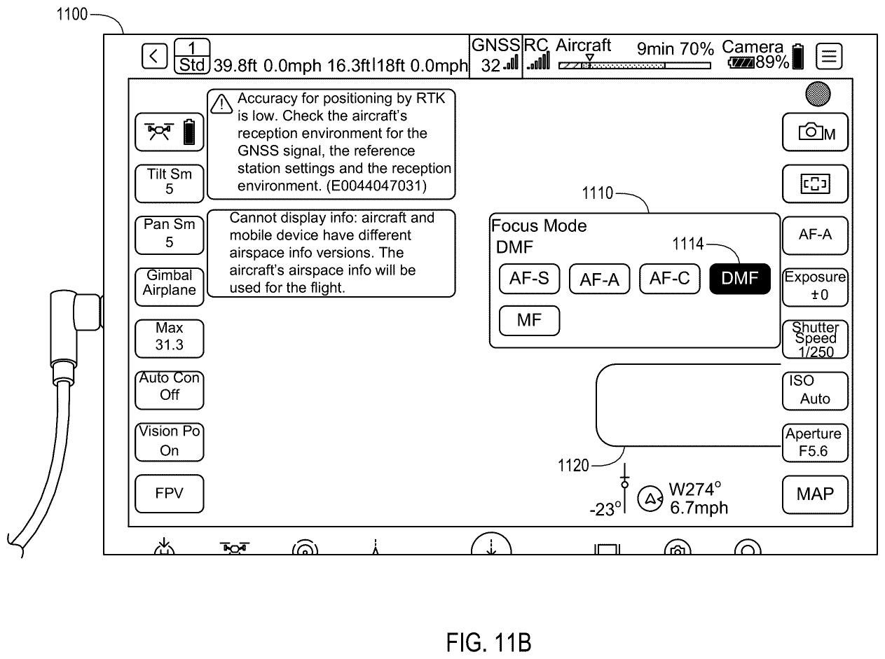

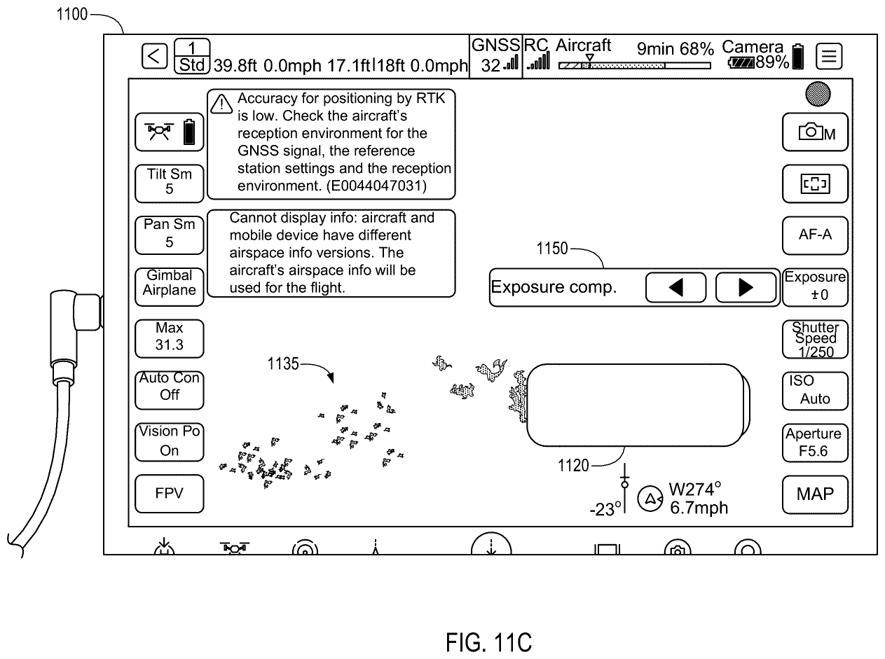

FIG. 11A illustrates a screenshot of a live video feed 1105 and control interface of a drone with a white-hot image rendering of a detected gas leakage event 1130 from a pipe 1120, according to one embodiment. The image is rendered on a screen of a display device 1100 that may be connected via a wire (or wirelessly) to antennas and/or a manual controller for the drone. A focus mode 1112 is selected via the focus mode selection interface 1110.

As illustrated, an operator of the drone may be able to control the drone via the interface and/or obtain various drone statistics and information (e.g., battery life, GPS location, camera status, etc.). Additionally, the interface allows for control of the camera functions and mapping formats. The video captured during an extended flight may be recorded as a single file (e.g., a 22-minute flight) or as multiple relatively large files (e.g., a new file for every 5 minutes of flight time). An event recording button is available to cause the system to automatically generate a segmented and/or annotated video clip of a detected or identified gas leakage event.

Thus, the system differs from a normal configuration that allows for “video recording” via a standard “record” button in a video interface. The presently described systems and methods include a functionality or user interface “record button” to initiate the continuous recording of an entire flight and a separate “event record button” that automatically extracts a segment of the video to be associated with a detected gas leakage event or makes annotations of beginning and end points within the continuous video for later extraction of a segment of the video feed associated with the detected gas leakage event.

In various embodiments, the user does not have to manually identify the beginning annotation and then subsequently identify the end annotation. Rather, the single selection of “record event” results in the automatic segmentation and/or annotation of a video clip. Each recorded event results in a segmented and/or annotated video clip with specific characteristics that are consistent and uniform with respect to the segmented and/or annotated video clips associated with other gas leakage events.

Moreover, the exact time that the operator selects the “record event” may not correspond directly to the beginning annotation or segmentation of the continuous video feed. Rather, the instruction provided by the operator to record an identified gas leakage event causes the drone to enter into an autonomous operation mode, during which the user loses manual control of the drone and/or the associated imaging system. The drone automatically positions itself and/or adjusts image capture settings and positioning to capture a portion of the video feed with specific “normalized” or standardized characteristics.

In some instances, the instruction to record an event may result in the immediate segmentation and/or annotation of a video clip, assuming that the drone positioning and camera settings are already correct for the normalized event recording. However, in most instances, the drone will respond by performing a NUC operation to normalize the image quality and move, stabilize, and/or reposition the drone prior to initiating the segmentation and/or annotation of the continuous video feed or continuous video recording to generate the video clip for the report of the detected gas leakage event. Thus, there may be several seconds of delay, repositioning of the drone and/or camera, and/or calibration of the imaging sensors that occur between the moment that the operator instructs the system to capture an event and when the actual event data is captured.

FIG. 11B illustrates a screenshot of a live video feed and control interface of a drone with a black-hot image rendering of a detected gas leakage event, according to one embodiment. A different focus mode 1114 is selected via the focus mode selection interface 1110. In the black-hot image rendering, the gas leakage event from the pipe 1120 is barely visible or not visible.

FIG. 11C illustrates a screenshot of a live video feed and control interface of a drone with a white-hot image rendering of a detected gas leakage event 1135 from the pipe 1120 in GDM mode with the gas movement rendered in green, according to one embodiment. Exposure compensation controls 1150 can be used to improve the visualization of the gas leakage event 1135.

This disclosure has been made with reference to various embodiments, including the best mode. However, those skilled in the art will recognize that changes and modifications may be made to the embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

What is claimed is:

1. A system to detect and report gas leaks, comprising:
an unmanned aerial vehicle (UAV) to navigate a flight path according to a predefined route or manual control of a human operator;
an infrared imaging sensor onboard the UAV to capture a continuous video feed of an area under inspection;
a detection subsystem to:
detect a gas leakage event in the captured continuous video feed, and generate an annotation to mark a segment of the continuous video feed corresponding to the gas leakage event;
an incident reporting subsystem to:
implement a non-uniformity correction (NUC) process on the annotated segment to normalize image quality and capture,
temporarily disable manual control of the UAV,
autonomously adjust UAV positioning and imaging parameters to capture a standardized video clip of the gas leakage event under standardized capture conditions,
capture, via the infrared imaging sensor, the standardized video clip of the gas leakage event within the continuous video feed, and
re-enable manual control of the UAV after capturing the standardized video clip;
a metadata embedding module to insert metadata within the annotated video clip, the metadata including at least a timestamp, GPS coordinates, wind speed, wind direction, and UAV positioning data; and
a reporting subsystem to process the continuous video feed, extract the standardized video clip of the gas leakage event using the annotation, format the extracted video clip and metadata into a standardized incident report, and transmit the standardized incident report to a remote computing system for integration into a leak detection and repair (LDAR) workflow.

2. The system of claim 1, wherein the detection subsystem comprises at least one of: an artificial intelligence (AI)-based or machine learning (ML)-based algorithm to detect the gas leakage event in the captured video feed.

3. The system of claim 1, wherein the detection subsystem autonomously adjusts the UAV positioning by adjusting an altitude and an orientation relative to the detected gas leakage event.

4. The system of claim 1, wherein the standardized capture conditions include predefined imaging parameters, including at least one of: a frame rate, an exposure setting, a gain setting, and a lens focal length setting.

5. The system of claim 1, wherein the NUC process further comprises performing a flat-field correction (FFC) to eliminate non-uniformities in the captured infrared video feed before capturing the standardized video clip.

6. The system of claim 1, wherein the metadata embedding module further inserts environmental data including air temperature, humidity, and atmospheric pressure at the time of the gas leakage event.

7. The system of claim 1, wherein the UAV includes an auxiliary visible light camera configured to capture visual confirmation images of the gas leakage event along with the infrared video feed.

8. The system of claim 1, wherein the detection subsystem further comprises a laser-based gas detection system configured to detect the presence of specific gas types.

9. The system of claim 8, wherein the reporting subsystem is further configured to overlay gas concentration data from the laser-based gas detection system onto the video feed.

10. The system of claim 1, wherein the reporting subsystem is further configured to include a map showing the gas leakage event within the standardized incident report.

11. The system of claim 1, wherein the UAV includes a GPS-guided autonomous flight mode to perform systematic surveys of an inspection area without manual control.

12. The system of claim 1, wherein the standardized incident report is formatted for compatibility with an application programming interface (API) of a third-party leak detection and repair (LDAR) management system.

13. A method for detecting and reporting gas leaks using an unmanned aerial vehicle (UAV), the method comprising:
capturing, via an infrared imaging sensor onboard the UAV, a continuous video feed of an area under inspection;
detecting, via a detection subsystem, a gas leakage event in the captured continuous video feed;
automatically generating an annotation in response to detecting the gas leakage event, wherein the annotation marks a segment of the continuous video feed corresponding to the gas leakage event;
implementing, via an onboard incident reporting subsystem, a non-uniformity correction (NUC) process on the annotated segment to normalize image quality;
disabling, temporarily, manual control of the UAV and autonomously adjusting UAV positioning and imaging parameters to capture a standardized video clip of the gas leakage event under standardized capture conditions;
capturing, via the infrared imaging sensor, the standardized video clip of the gas leakage event within the continuous video feed;
re-enabling manual control of the UAV after capturing the standardized video clip;
embedding metadata within the annotated video clip, the metadata including at least a timestamp, GPS coordinates, wind speed, wind direction, and UAV positioning data; and
processing, via a reporting subsystem, the continuous video feed, wherein processing the continuous video feed includes:
extracting the standardized video clip of the gas leakage event from the segmented portion of the continuous video feed using the annotation;
formatting the extracted video clip and metadata into a standardized incident report; and
transmitting the standardized incident report to a remote computing system for integration into a leak detection and repair (LDAR) workflow.

14. The method of claim 13, wherein the standardized incident report is formatted for compatibility with an application programming interface (API) of a selected leak detection and repair (LDAR) program.

15. The method of claim 13, wherein autonomously adjusting UAV positioning comprises implementing a predefined event flight pattern relative to the location of the identified gas leakage event.

16. The method of claim 13, wherein the UAV further includes a secondary imaging sensor to capture visual spectrum images synchronized with the infrared imaging sensor.

17. The method of claim 13, wherein the LDAR workflow integration comprises transmitting the standardized incident report via a secure communication protocol, including encryption for data integrity and authentication.

18. A system to detect and report gas leaks, comprising:
a UAV to navigate a flight path and capture a continuous video feed of an inspection area via an onboard infrared imaging sensor;
a detection subsystem to:
detect a first gas leakage event in the captured video feed and generate a first annotation marking a first segment of the video feed corresponding to the first detected gas leakage event, and
detect a second gas leakage event in the captured video feed and generate a second annotation marking a second segment of the video feed corresponding to the second detected gas leakage event; and
a processing system to extract individual standardized video clips of each of the first and second detected gas leakage events based on the first and second annotations; and
a reporting subsystem to generate a report with an API-compatible data structure for integration with external leak detection and repair (LDAR) management systems, wherein the report includes:
a structured output directory containing a folder for each detected gas leakage event, where each folder includes at least one segmented video file, associated metadata, and data visualizations, and
a summary report with embedded video previews, timestamps, GPS coordinates, environmental conditions.

19. A system for detecting and reporting gas leaks, comprising:
a gas imaging system to capture a continuous video feed of an area under inspection using an optical gas imaging (OGI) camera;
a detection subsystem to:
detect a gas leakage event in the captured video feed, and
generate an annotation marking a segment of the video feed corresponding to the detected gas leakage event;
a processing subsystem to extract standardized video clips corresponding to the detected gas leakage event, embed metadata within the video clips, and generate a structured incident report containing the annotated video clips, metadata, and associated visualizations; and
a reporting subsystem to transmit the structured incident report to an external computing system for integration into a leak detection and repair (LDAR) workflow.

20. The system of claim 19, wherein the gas imaging system is mounted on a handheld device.

21. The system of claim 19, wherein the gas imaging system is mounted on a ground-mounted fixed installation.

22. The system of claim 19, wherein the gas imaging system is mounted on a manned aerial vehicle.

23. The system of claim 19, wherein the gas imaging system is mounted on an unmanned aerial vehicle (UAV).

24. The system of claim 19, wherein the gas imaging system is mounted on an unmanned ground vehicle (UGV).
